(19) United States
(12) Patent Application Publication
(10) Pub. No.: US 2015/0047641 A1
(43) Pub. Date: Feb. 19, 2015

(54) AIR FILTER EQUIPPED NOSE CLIP

(71) Applicant: Fred Frey, Deerfield Beach, FL (US)

(72) Inventor: Fred Frey, Deerfield Beach, FL (US)

(21) Appl. No.: 13/970,093

(22) Filed: Aug. 19, 2013

(51) Int. Cl. A62B 23/06

(52) U.S. Cl. CPC A62B 23/06
USPC 128/206.11

(57) ABSTRACT

An air filter equipped nose clip is provided. The air filter equipped nose clip includes an air filter sandwiched between a disk with a plurality of apertures and an end cap. The disk, air filter, and end cap are coupled at each end of a connector.

### BACKGROUND OF THE INVENTION

1. Field of the Invention

The present invention relates to air filters and more particularly to personal air filters.

2. Description of the Related Art

The air one breathes is dirty. As it is well known, in addition to nitrogen, oxygen, carbon dioxide, water vapor, and other gases, air includes a number of contaminants, including, solid, germ, and gas phase contaminants. Solid contaminants can include organic and inorganic particulates; germ contaminants can include bacteria, viruses, and fungi; gas phase contaminants can include gas molecules and odors. Simply put, breathing dirty air sickens people and in extreme cases, can cause death.

To improve air quality, people have employed air purifiers to remove contaminants from the air. Air purifiers use different purifying techniques to remove dust, pollen, mold, pet dander, dust mite feces, and bacteria from the air. The purifying techniques can include ultraviolet irradiation, ozone generators, activated carbon, and ionizer purifiers. Even still, common air purifying techniques can be undesirable because each may produce gaseous by-products, create high noise levels, and/or consume too much electrical power. In addition, air purifiers are limited to indoor use.

### BRIEF SUMMARY OF THE INVENTION

Embodiments of the present invention address deficiencies of the art with respect to personal air filters and provide a novel and non-obvious apparatus for filtering air. In an embodiment of the invention, an air filter equipped nose clip can include a connector and a disk with a plurality of apertures coupled proximate to each end of the connector. The air filter equipped nose clip can further include an air filter comprising an activated carbon fiber filtering sponge disposed above each disk on the connector and an end cap including a plurality of fingers radiating from the center of the end cap coupled to each end of the connector and disposed above the air filter.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred; it being understood, however, that the invention is not limited to the precise arrangements and instrumentalities shown, wherein:

FIG. 1 is a view of an air filter equipped nose clip in an embodiment of the invention;

FIG. 2 is a view of the air filter equipped nose clip of FIG. 1;

FIG. 3A is a view of an air filter equipped nose clip in an embodiment of the invention;

FIG. 3B is a view of an air filter equipped nose clip in an embodiment of the invention.

FIG. 4A illustrates an embodiment of the invention inserted into the nostrils of a person;

FIG. 4B illustrates an embodiment of the invention inserted into the nostrils of a person;

FIG. 5 illustrates a method for manufacturing an air filtered equipped nose clip;

FIG. 6A is a view of an air filter equipped nose clip in an embodiment of the invention;

FIG. 6B is a top view of an air filter equipped nose clip in an embodiment of the invention;

FIG. 6C is a bottom view of an air filter equipped nose clip in an embodiment of the invention;

FIG. 6D illustrates a partially assembled air filter equipped nose clip;

FIG. 7A is a view of an air filter equipped nose clip in an embodiment of the invention; and,

FIG. 7B illustrates a partially assembled air filter equipped nose clip in an embodiment of the invention.

### DETAILED DESCRIPTION OF THE INVENTION

Embodiments of the invention provide for an air filter equipped nose clip. In accordance with an embodiment of the invention, an air filter equipped nose clip can include a connector with a disk disposed proximate to each end of the connector. An air filter can be disposed above each disk, and an end cap can be disposed above the air filter, so that the air filter is sandwiched between the disk and the end cap. The disk additionally can include multiple, different openings, that allow contaminated air to flow through the disk and through the air filter which in turn can remove contaminants from the air. By inserting the air filter equipped nose clip into one's nostrils, odors and germs present within the surrounding dirty air can be directly filtered by the individual irrespective of whether the individual breathes air outdoors or indoors.

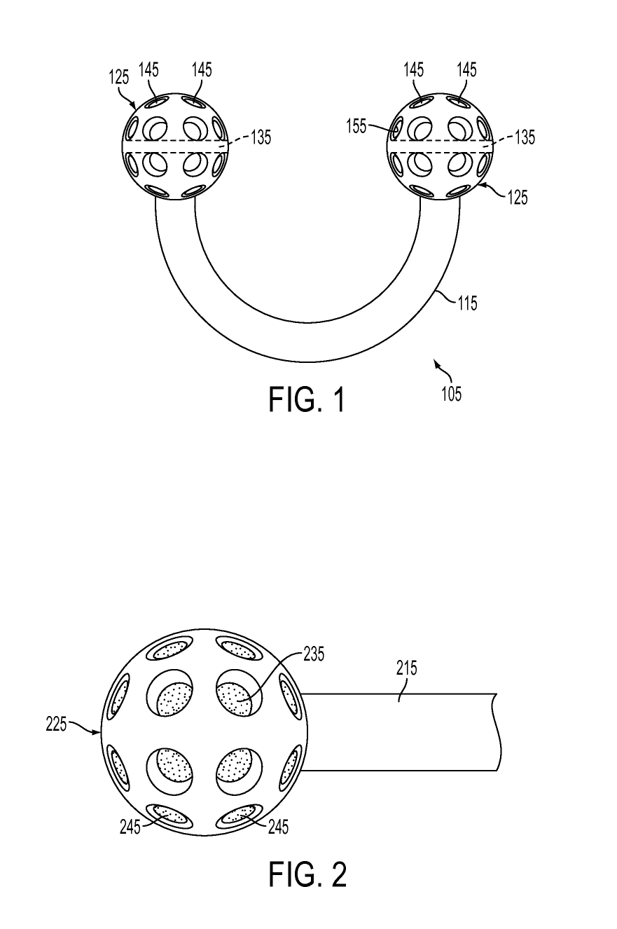

In further illustration, FIG. 1 shows a view of an air filter equipped nose clip arranged in accordance with one embodiment of the invention. As shown in FIG. 1, an air filter equipped nose clip 105 can include a U-shaped body 115, for example formed from silicone. In a different embodiment, the U-shaped body 115 can be formed from a rubberized plastic, such as thermoplastic rubber (TPR). It is to be understood, however, that the material used to form the U-shaped body 115 is not so limited to merely silicone or plastic and other materials can suffice such as gold, titanium, stainless steel, platinum, and surgical steel, as well as glass, rubber, other polymers and acrylic. The U-shaped body 115 can vary in size to fit a variety of noses. It is understood that the different components of the air filter equipped nose clip 105, and thus, the nose clip 105 itself can vary in size to fit a variety of noses.

A housing 125 can be affixed to each end of the U-shaped body 115. For instance, each housing 125 can be spherically-shaped; however, alternatively, each housing 125 can be ovoid-shaped. Further, each housing 125 can be conical-shaped. Each housing 125 can be made of any soft flexible material, such as, but not limited to, silicone, latex, rubber, including thermoplastic rubber (TPR), natural sponge, cellulose wood fibers, or polymer. The housing 125 further includes multiple, different apertures 145. The apertures 145 are not limited to a specific shape. For instance, the apertures 145 can be round, diamond, oval, and rectangular.

The construction of each housing 125 is not limited to a particular method. In an embodiment, the U-shaped body 115 and each housing 125 can be made as one piece. In another embodiment, the U-shaped body 115 can be made separately from each housing 125; a housing 125 can then be coupled to each end of the U-shaped body 115. The method of coupling can include, but is not limited to, gluing, fastening, and welding. Further, the housing 125 can include a (screw) thread so that the U-shaped body 115 (with an opposing thread) can be coupled. In addition, the housing 125 can be made as one piece or multiple pieces that are affixed to each other, by any method, for instance by gluing, welding, or fastening.

Disposed within each housing 125 is an air filter 135. In an embodiment, the air filter 135 can be glued in each housing 125, so that the air filter 135 is horizontally positioned between a portion of an interior wall 155 of the housing 125 and an opposite portion of the interior wall 155. Further, in an embodiment, the air filter 135 is affixed in such a way to bisect (in two approximately equal halves) the housing 125, thus creating two approximately equally-sized cavities in the housing 125. Alternatively, the air filter 135 can be affixed in the housing 125, such that the housing 125 is unevenly bisected. In yet a different embodiment, the air filter 135 can be disposed in the housing 125, such that the air filter 135 is not affixed.

The air filter 135 can comprise a nonwoven fabric, such as polypropylene (polypropene) or felt. Further, the nonwoven fabric can include spunmelt fabrics. Of note, as used herein, spunmelt refers to both meltblown and spunbond (spunlaid) fabrics. In an embodiment, the air filter 135 can be formed from a surgical mask. In addition, the surgical mask can be from at least a three-ply surgical mask. Alternatively, the air filter 135 can be made from natural sponge, cotton, or wool.

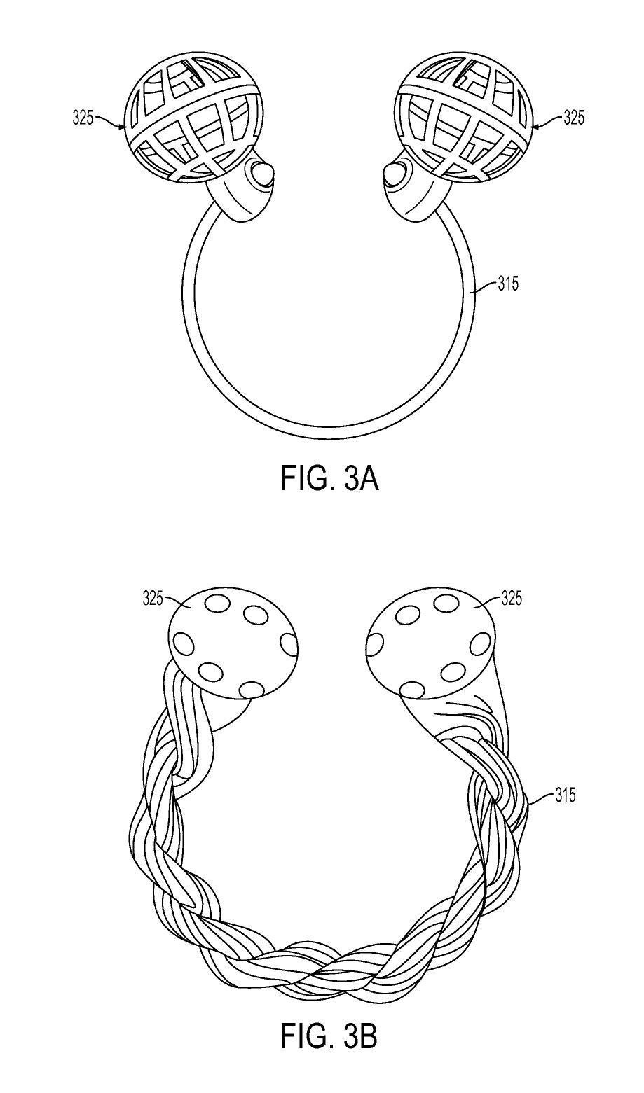

In even further illustration, FIG. 2 is a view of the air filter equipped nose clip of FIG. 1. The air filter equipped nose clip can include a U-shaped body 215 with a housing 225 coupled to each end of the U-shaped body 215. In an embodiment, the housing 225 can be spherical-shaped and contain a multiplicity of apertures 245. An air filter 235 can be positioned parallel to a horizontal axis of the housing 225. In an embodiment, the air filter 235 can be positioned in the housing 225 along the horizontal axis that bisects the housing 225 into two equal halves. In a different embodiment, the air filter 235 can be positioned in the housing 225 along a horizontal axis of the housing 225 such that unequal halves of the housing 225 are created.

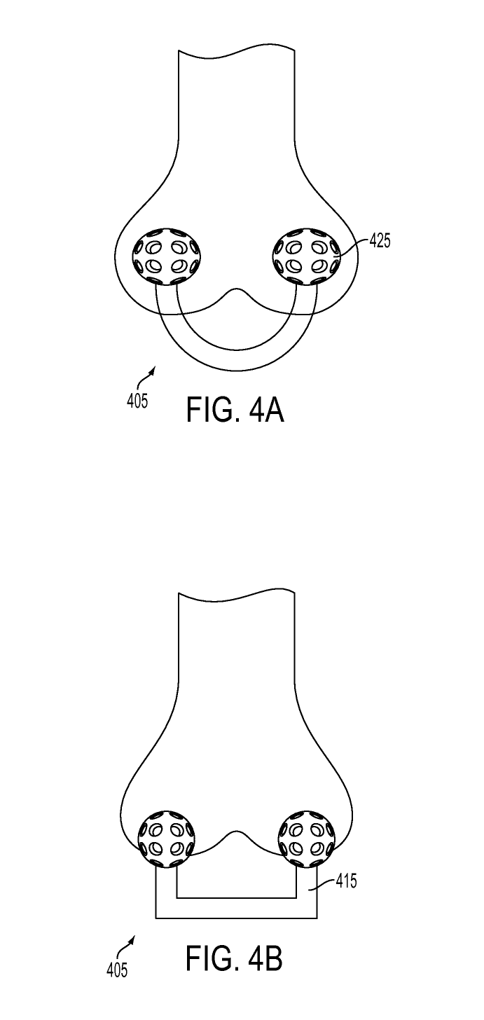

In yet even further illustration, FIGS. 3A and 3B are views of an air filter equipped nose clip in accordance with additional embodiments of the invention. As shown in FIG. 3A, a U-shaped body 315 made from a metal ring, such as titanium, gold, silver, or surgical steel, can have a housing 325 disposed at each end of the U-shaped body 315. An air filter (not pictured) can be disposed within each housing 325. FIG. 3B illustrates a U-shaped body 315 made from rope that can have a housing 325 disposed at each end. The rope can be made of any material now known or later developed, such as, but not limited to, cotton, hemp, linen, sisal, jute, polyester, nylon, other polymers, and metal, for instance, gold, silver, and steel. In addition, an air filter (not shown) can be disposed within each housing 325.

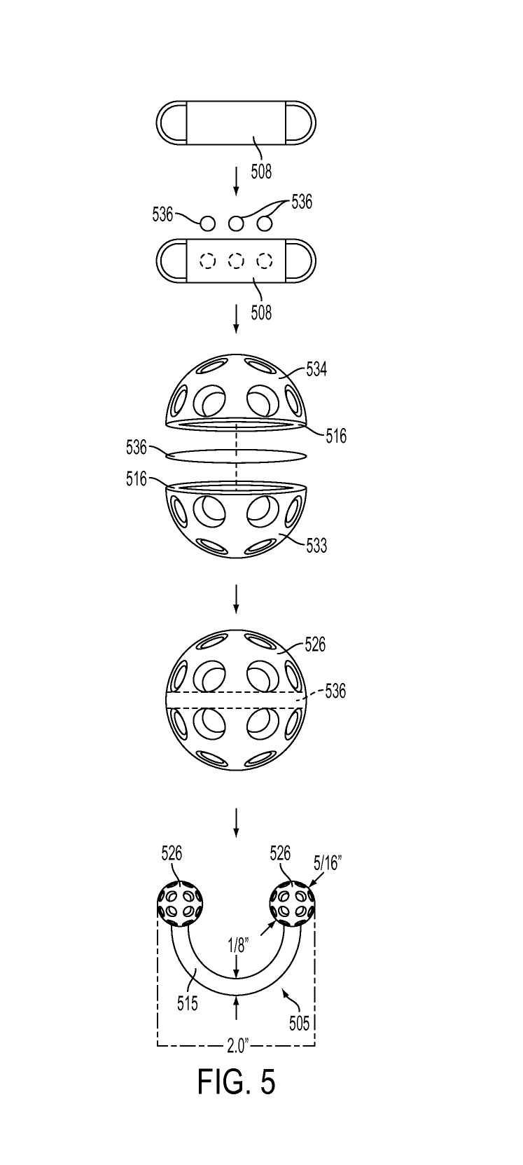

In further illustration, FIGS. 4A and 4B illustrate embodiments of the invention inserted into the nostrils of a person. FIG. 4A shows that the housing of the air filter equipped nose clip 405 can be fully inserted into a nose. Of note, the housing 425 in FIG. 4A is ovoid-shaped. FIG. 4B illustrates that the housing of the air filter equipped nose clip 405 can be partially inserted into a nose. Further FIG. 4B illustrates that the U-shaped body 415 can include a more rectangular-shaped U-shaped body 415. In other words, a U-shaped body 415 can refer to a general U-shape, which can include a more rectangular-shaped body as shown in FIG. 4B, a traditional U-shape (rounded bottom) as illustrated in FIG. 4A, or a U-shaped body with angular corners, for instance a U-shape body in the shape of half of a hexagon (not shown).

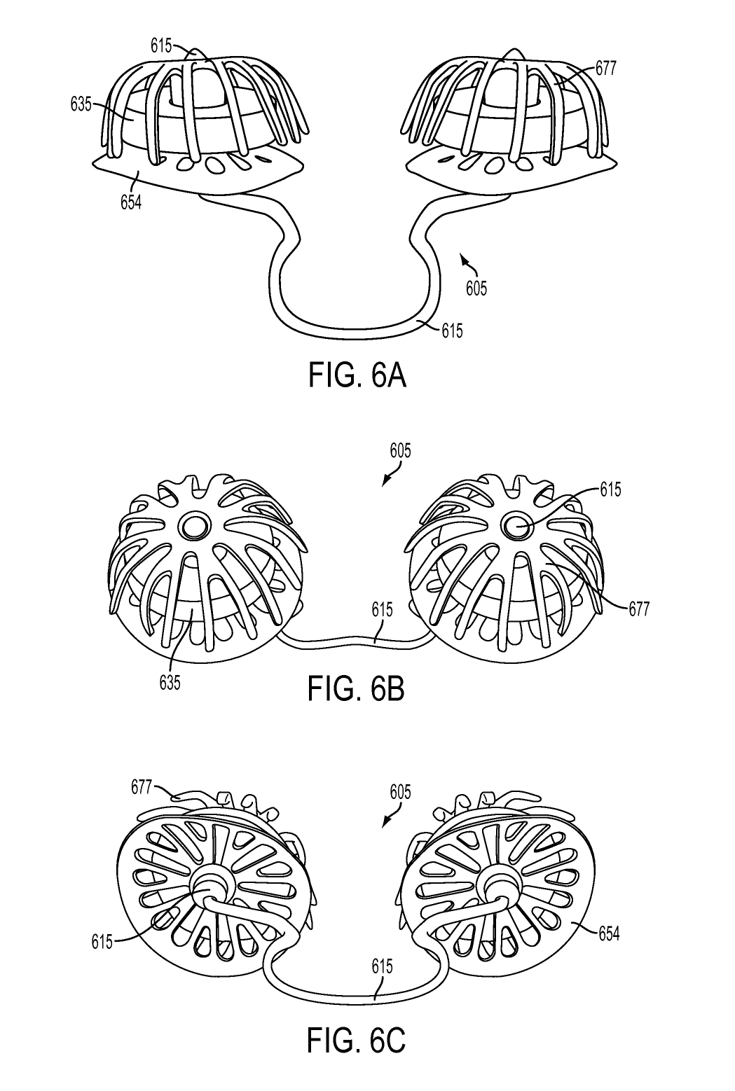

In further illustration, FIG. 5 illustrates a method for manufacturing an air filtered equipped nose clip 505. The method of manufacturing can include forming a circular air filter 536 for disposition in a spherical housing by creating from a surgical mask 508 a circular portion from the surgical mask 508. The circular air filter 536 can be affixed by glue to a rim 516 of a first portion of the housing 533. The first portion of the housing 533 corresponds to a second portion of the housing 534. The coupling of the first portion 533 to the second portion 534 forms a coupled spherical housing 526 (with the now affixed circular air filter 536). Specifically, the rim 516 of the first portion 533 can then be coupled with glue to the rim 516 of the second portion 534. The coupled spherical housing 526 can be affixed to an end of a U-shaped body 515. A second coupled spherical housing can be affixed to a different end of the U-shaped body 515 to form the air filter equipped nose clip 505. Each spherical housing 526 can be affixed by glue, screw threads on each spherical housing 526 and on each different end of the U-shaped body 515, or by any other method now known or later developed, so that a spherical housing 526 can be affixed to each different end of the U-shaped body 515. In an embodiment, the diameter of the U-shaped body 515 can be approximately one-eighth of an inch and the diameter of each spherical housing 526 can range from approximately three-sixteenths of an inch to seven-sixteenths. In addition, the total length (from outer diameter on one spherical housing 526 to the outer diameter of the second spherical housing 526) can be approximately two inches.

It is to be understood that the process to manufacture the air filter equipped nose clip 515 may be modified depending on how the housing (without the air filter) and the U-shaped body 515 is manufactured. For instance, the housing (with no air filter) can be manufactured in pieces, for instance as two halves, to which the air filter is attached to at least one piece. Each piece can then be affixed to a different piece to form a coupled spherical housing 526 (with air filter). Alternatively, the housing (without the air filter) can be manufactured as one piece which is then cut in some manner, such that the air filter can be inserted and attached, if desired. The different pieces of the housing can then be rejoined to form the coupled spherical housing 526 (containing an air filter). Alternatively, the U-shaped body 515 and a first portion of the spherical housing 533 can be manufactured as one piece and an air filter 536 can be secured to the first portion of the spherical housing 533. The remaining part of the housing 534 (a second portion) can then be attached to first portion to form a coupled spherical housing 526 with affixed an air filter 536.

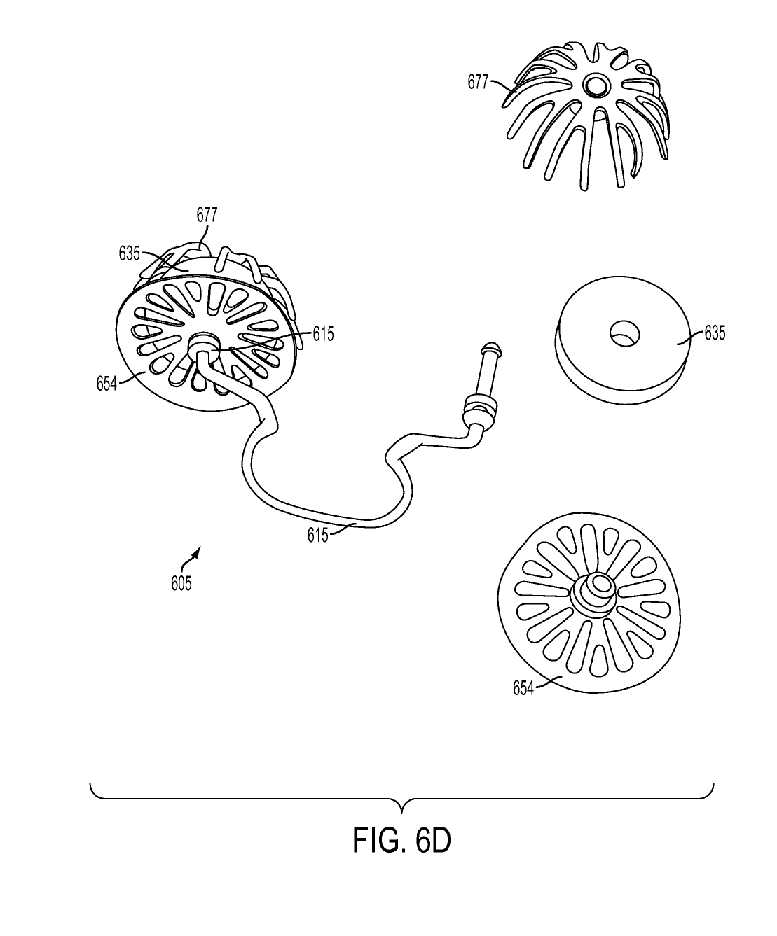

In even further illustration, FIGS. 6A through 6D are views of an air filter equipped nose clip 605 in accordance with an additional embodiment of the invention. More specifically, FIG. 6A shows an embodiment of an air filter equipped nose clip 605 with a connector 615. The connector 615 can be predominantly U-shaped. The connector 615 can also be unibody construction. In addition, the connector 615 can be made from silicone or thermoplastic rubber (TPR) (also known as thermoplastic elastomer), but the connector 615 is not limited to these two materials. On the connector 615, a disk 654 can be coupled proximate to each end of the connector 615; in other words, there are a total of two disks 654, one proximate to each end of the connector 615. In an embodiment, each disk 654 is affixed to the connector 615 via a snap fit mechanism. In addition, the disk 654 can include multiple, different apertures. Further, the disk 654, in an embodiment, can be made from polypropylene (also known as polypropene). In yet different embodiments, the disk 654 can be made of other materials, including, but not limited to thermoplastic rubber and silicone.

Placed above the disk 654 proximate to each end of the connector 615 can be an air filter 635. The air filter 635, in an embodiment, can be an activated carbon fiber filtering sponge. Disposed above each disk 654 on the connector 615 can be an end cap 677. The end cap 677 can be made from polypropylene in an embodiment, but in different embodiments each end cap 677 can be made of other materials, including but not limited to thermoplastic rubber and silicone. The end cap 677 can include multiple, different fingers radiating from the approximate center of the end cap 677. Further, each end cap 677 can be affixed to the connector 615 via a snap fit mechanism. In this way, the end cap 677 prevents the filter 635 from falling off the connector 615.

In further illustration, FIG. 6B shows a top view of the air filter equipped nose clip 605 of FIG. 6A with a connector 615, two disks 654, two air filters 677, and two end caps 677. In yet further illustration, FIG. 6C shows a bottom view of the air filter equipped nose clip 605 of FIG. 6A with a connector 615, two disks 654, two air filters 677, and two end caps 677. Finally, FIG. 6D illustrates a partially assembled air filter equipped nose clip 605 of FIG. 6A with a connector 615, two disks 654, two air filters 635, and two end caps 677. Of note, it is contemplated that in an embodiment of the invention, the air filter equipped nose clip 605 does not include a disk 654, but instead includes a connector 615 with an air filter 635 coupled proximate to each end of the connector 615 and an end cap 677 coupled to each end of the connector 615 and disposed above each air filter 635. Of further note, the filter equipped nose clip 605 can be disposable.

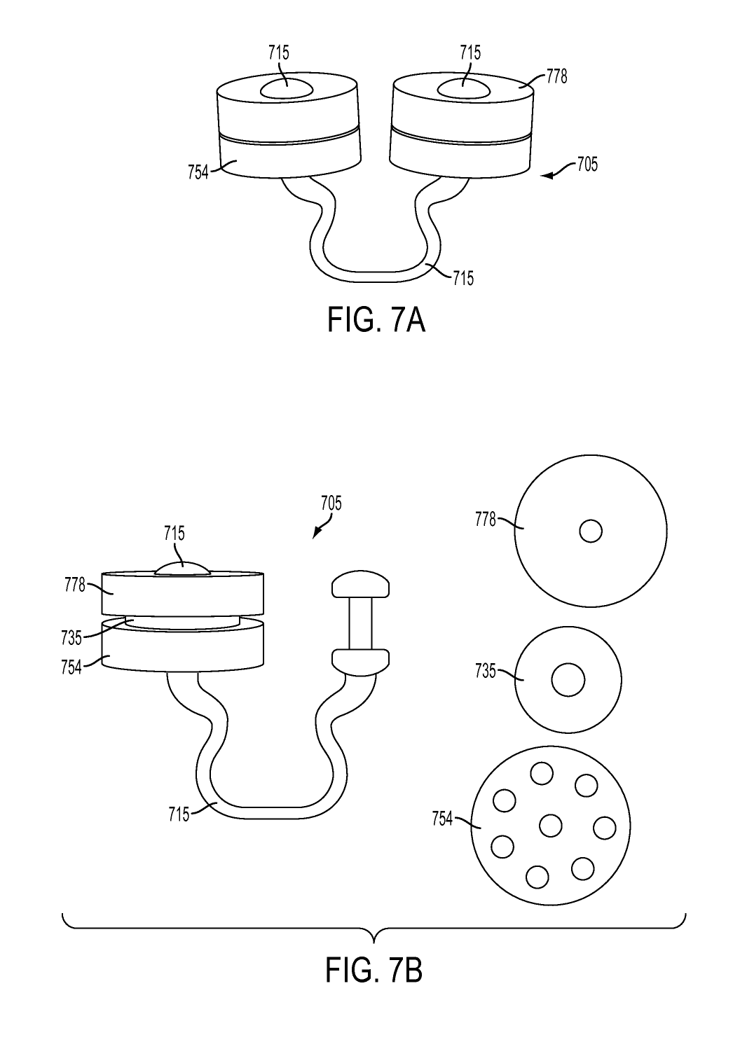

In even yet further illustration, FIGS. 7A and 7B illustrate additional embodiments of an air filter equipped nose clip 705 in an embodiment of the invention. In FIG. 7A, an air filter equipped nose clip 705 with a connector 715 can be provided. The connector 715 can also be unibody construction. Coupled to the connector 715 proximate to each end of the connector can be a disk 754 with a multiple, different apertures. Disposed above each disk 754 can be a filter 735 (see FIG. 7B). The filter 735 can be made from a non-woven material, such as polypropylene in an embodiment, but in a different embodiment, can be made from other materials, such as carbonized paper. Disposed above each filter 735 is a second disk 778. Both the (bottom, first) disk 754 and the (top) second disk 778 can be made from a nonwoven fabric, such as polypropylene. Finally, FIG. 7B illustrates a partially assembled air filter equipped nose clip 705 of FIG. 7A with a connector 715, two (bottom) disks 754, two air filters 735, and two top disks 778. Of further note, the filter equipped nose clip 705 can be disposable.

Having thus described the invention of the present application in detail and by reference to embodiments thereof, it will be apparent that modifications and variations are possible without departing from the scope of the invention defined in the appended claims as follows:

I claim:

1. An air filter equipped nose clip, comprising:
a connector;
a disk including a plurality of apertures coupled proximate to each end of the connector;
an air filter disposed above each disk on the connector, the air filter comprising an activated carbon fiber filtering sponge; and,
an end cap including a plurality of fingers radiating from the center of the end cap coupled to each end of the connector and disposed above the air filter.

2. The air filter equipped nose clip of claim 1, wherein the connector is made from silicone.

3. The air filter equipped nose clip of claim 1, wherein the connector is made from thermoplastic rubber.

4. The air filter equipped nose clip of claim 1, wherein the end cap is made from polypropylene.

5. The air filter equipped nose clip of claim 1, wherein the end cap is affixed to the connector via a snap fit mechanism.

6. The air filter equipped nose clip of claim 1, wherein the disk is affixed to the connector via a snap fit mechanism.

7. The air filter equipped nose clip of claim 1, wherein the disk is made from polypropylene.

8. The air filter equipped nose clip of claim 1, wherein the connector is made from silicone.

9. An air filter equipped nose clip, comprising:
a thermoplastic rubber connector;
an air filter coupled proximate to each end of the connector, the air filter comprising an activated carbon fiber filtering sponge; and,
a polypropylene end cap including a plurality of fingers coupled to each end of the connector and disposed above the air filter.

10. The air filter equipped nose clip of claim 9, further comprising a polypropylene disk including a plurality of apertures coupled proximate to each end of the connector below the air filter.
